(19) United States
(12) Patent Application Publication
(10) Pub. No.: US 2025/0022020 A1
(43) Pub. Date: Jan. 16, 2025

(54) SYSTEMS AND METHODS FOR AUDIENCE FEEDBACK GUIDED MIXED REALITY

(71) Applicant: JPMORGAN CHASE BANK, N.A., New York, NY (US)

(72) Inventors: Matt GOTTSACKER, Orlando, FL (US); Mengyu CHEN, Los Angeles, CA (US); David SAFFO, New York, NY (US); Feiyu LU, New York, NY (US); Blair MACINTYRE, Westwood, MA (US)

(21) Appl. No.: 18/769,647

(22) Filed: Jul. 11, 2024

Related U.S. Application Data
(60) Provisional application No. 63/513,662, filed on Jul. 14, 2023.

(51) Int. Cl. G06Q 30/0282; G06F 3/14

(52) U.S. Cl. CPC G06Q 30/0282; G06F 3/1454

(57) ABSTRACT

Systems and methods for audience feedback guided mixed reality are disclosed. According to an embodiment, a method may include: (1) receiving, by a computer program executed on an electronic device, an instruction from a presenter electronic device for a presenter to present a presentation comprising content to an audience headset; (2) communicating, by the computer program, the content to the audience headset, where the audience headset presents the content; (3) receiving, by the computer program, feedback from the audience headset; (4) determining, by the computer program, an audience sentiment based on the feedback; (5) identifying, by the computer program, a recommendation for the presenter based on the audience sentiment; and (6) communicating, by the computer program, the recommendation to the presenter electronic device.

### RELATED APPLICATIONS

This application claims priority to, and the benefit of, U.S. Provisional Patent Application Ser. No. 63/513,662, filed Jul. 14, 2023, the disclosure of which is hereby incorporated, by reference, in its entirety.

### BACKGROUND OF THE INVENTION

### 1. Field of the Invention

Embodiments relate to systems and methods for audience feedback guided mixed reality.

### 2. Description of the Related Art

In client meetings, a presenter often needs to present an audience of a variety of product information or concepts based on the audience's individual needs. An example of such a presentation is a financial product meeting. The audience's level of knowledge in the subject matter is unpredictable, and the audience often needs detailed explanation and customized walkthrough over specific details and examples. For example, some audiences may need an introductory financial literacy education before getting into the detail of financial products.

Due to this uncertainty, presenters often need to adjust their presentation content and create original information display (draw sketches with paper and pen, pull up reference images, etc.) to elaborate their presentation content. Existing methods are very ad-hoc and it is difficult for the presenters to know how effective or how understandable their presentation content is. And any original content that the presenter creates may be lost.

### SUMMARY OF THE INVENTION

Systems and methods for audience feedback guided mixed reality are disclosed. According to an embodiment, a method may include: (1) receiving, by a computer program executed on an electronic device, an instruction from a presenter electronic device for a presenter to present a presentation comprising content to an audience headset; (2) communicating, by the computer program, the content to the audience headset, where the audience headset presents the content; (3) receiving, by the computer program, feedback from the audience headset; (4) determining, by the computer program, an audience sentiment based on the feedback; (5) identifying, by the computer program, a recommendation for the presenter based on the audience sentiment; and (6) communicating, by the computer program, the recommendation to the presenter electronic device.

In one embodiment, the content may include augmented reality or virtual reality content.

In one embodiment, the content may include three-dimensional content.

In one embodiment, the feedback may include an eye gaze/focal point, a gesture, a movement, and/or audio.

In one embodiment, the audience sentiment may be determined using a trained machine learning model.

In one embodiment, the recommendation may include adjusting a tempo of the presentation.

In one embodiment, the recommendation may include additional content to present. In one embodiment, the additional content may be identified using a large language model.

In one embodiment, the method may also include: identifying, by the computer program, a portion of the content being presented; and causing, by the computer program, the audience headset to display the portion of the content as highlighted or emphasized.

In one embodiment, the method may also include:

communicating, by the computer program, an audience view to the presenter electronic device, wherein the presenter electronic device displays the audience view.

According to another embodiment, a system may include: an audience headset; a presenter electronic device for a presenter; and a computer program executed by an electronic device that receives an instruction from the presenter electronic device to present a presentation comprising content to the audience headset, communicates the content to the audience headset, receives feedback from the audience headset, determines an audience sentiment based on the feedback, identifies a recommendation for the presenter based on the audience sentiment, and communicates the recommendation to the presenter electronic device.

In one embodiment, the content may include augmented reality or virtual reality content.

In one embodiment, the content may include three-dimensional content.

In one embodiment, the feedback may include an eye gaze/focal point, a gesture, a movement, and/or audio.

In one embodiment, the audience sentiment may be determined using a trained machine learning model.

In one embodiment, the recommendation may include adjusting a tempo of the presentation or additional content to present.

In one embodiment, the additional content may be identified using a large language model.

In one embodiment, the computer program identifies a portion of the content being presented and causes the audience headset to display the portion of the content as highlighted or emphasized.

In one embodiment, the computer program communicates an audience view to the presenter electronic device and the presenter electronic device displays the audience view.

In one embodiment, the presenter electronic device may include a presenter headset.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for audience feedback guided mixed reality according to an embodiment;

FIG. 2 illustrates a method for audience feedback guided mixed reality according to an embodiment;

FIG. 3 depicts an exemplary computing system for implementing aspects of the present disclosure.

### DETAILED DESCRIPTION OF PREFERRED EMBODIMENTS

Embodiments relate to systems and methods for audience feedback guided mixed reality.

Embodiments may support face-to-face (i.e., co-located) as well as remote presentations between a presenter (e.g., an advisor or agent) and an audience (e.g., a client), guided by real-time client feedback. The presenter may use a control interface (e.g., on a tablet, a desktop monitor with mouse or touchscreen input, etc.) to choose and control what objects (in digital form) are presented to the audience. The audience may consume the presented content in a mixed-reality headset and see the content as if it is placed in their physical room (e.g., on a table, attached to a wall) or in a fully virtual environment. Presented digital content include 2D/3D data visualization, 3D models, figures, tables, text, images, etc.

The presenter may change or manipulate the data visualization shown to the audience by selecting data source, visualization types, or data mapping methods via the control interface. The changes made by the presenter may update in real-time in the mixed reality view of the audience.

The presenter may see what the audience is seeing in the mixed reality headset and may verbally guide the audience to focus on certain area(s) of the presentation. The presenter may also control the position, orientation and scale of the presented content with respect to the audience's body and their physical environment.

On the audience side, the audience can walk around the augmented display content and may touch certain areas of the content to view more details (e.g., information of each data point, or captions of figures and tables).

In embodiments, the audience may also control data objects by, for example, scrolling and panning on the 3D geo-spatial data visualization. Such actions will also be reflected in the presenter's instance of data visualization. Any interactions on the audience side may be reflected in the presenter's view of what the audience is seeing.

In embodiments, a real-time monitoring algorithm may collect the audience active and passive cues, such as gaze focus, hand/body movement, and spoken words, and then convert them into audience sentiment scores and engagement level index. Such audience feedback information may be then sent back to the presenter and processed into audience interest and content recommendations (e.g., graphs, product, educational material, etc.) that may be used to guide the presenter's presentation content. The suggestions include content recommendation, presentation tempo control, focus areas, etc. The presenter may review this information and act on the suggestions.

Embodiments thus disclose an audience feedback-guided mixed reality presentation system that allows a presenter to receive real-time audience feedback and content recommendation during their presentation. Embodiments may help the presenter understand the state of the audience and adjust the presentation material accordingly following the system generated suggestion to help the audience make informed decisions. An interactive system may enable face-to-face or remote presentation of objects.

Embodiments may provide an expressive information display that help the audience interactively learn about the products or become educated on concepts. Embodiments may mitigate the lack of effective methods to deliver multimedia content that is not prepared but requested by the audience during a meeting.

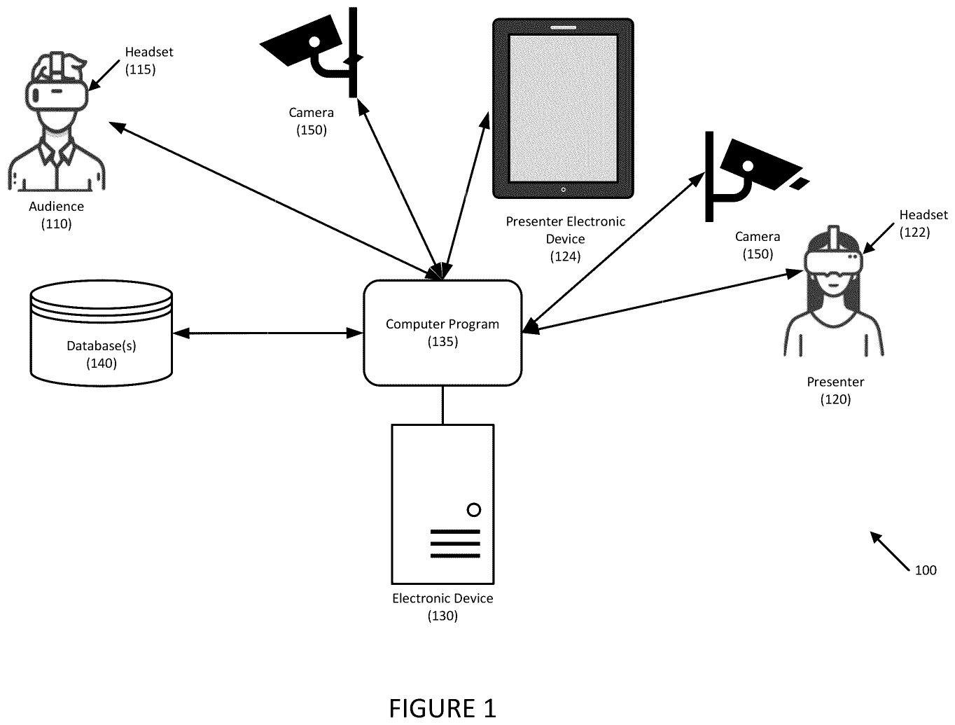

Referring to FIG. 1, a system for audience feedback guided mixed reality is disclosed according to an embodiment. System 100 may include audience 110, which may be one or more human beings, and presenter 120, which may also be one or more human beings. In one embodiment, audience 110 and presenter 120 may be co-located; in another embodiment, audience 110 and presenter may be located remotely from one another.

Audience 110 may be provided with headset 115, which may provide virtual reality or augmented reality to audience 110. Headset 115 may be provided with one or more screens, projectors, audio outputs, microphones, etc.

Headset 115 may monitor audience engagement using, for example, cameras to detect eye gaze for focal points, to detect an orientation of headset 115, and/or to capture what audience 110 is viewing. Headset 115 may include or interface with audience monitoring device, such as heart rate monitors, EKG monitors, pulse monitors, temperature monitors, etc.

Headset 115 may also capture gestures, such as hand/arm gestures, finger pointing, walking, etc., by audience 110. The gestures may be captured by camera(s) in headset 115, by external camera(s) 150 in the environment, etc.

Headset 115 may interface with computer program 135, which may be executed by electronic device 130, such as a server (e.g., physical and/or cloud-based), computers (e.g., workstations, desktops, laptops, notebooks, tablets, etc.), smart devices (e.g., smart phones, smart watches, etc.), Internet of Things (“IoT”) devices, etc.

Computer program 135 may also interface with presenter electronic device 124, such as a computer (e.g., a workstation, a desktop, a laptop, a notebook, a tablet, etc.), a smart device (e.g., a smart phone, a smart watch, etc.), an IoT device, etc. Computer program 135 may receive instructions from presenter 120 via presenter electronic device 124 to present content on headset 115. The content may be stored in database 140.

Computer program 135 may also receive feedback from headset 115, such as eye gaze, pulse rate, temperature, audio, gestures, etc. and may determine an audience sentiment for the audience. Examples of audience sentiment may include engaged, confused, not engaged, etc. From the audience sentiment, computer program 135 may provide recommendations on adjusting the presentation to presenter electronic device 124, such as additional content to present, whether to adjust a tempo of the presentation (e.g., slow down or speed up), certain content to emphasize, etc. In one embodiment, computer program 135 may automatically identify content being discussed and may highlight that content in the display of headset 115.

In another embodiment, presenter 120 may manually highlight content, areas of interest in the scene, etc. to emphasize using, for example, a virtual laser pointer or similar.

Presenter 120 may be presented with a visual of what the audience is seeing on presenter electronic device 124, as well as with recommendations, presentation cues, etc.

Presenter 120 may be provided with presenter headset 122, which may be similar to audience headset 115. Presenter 120 may be provided with similar information as is presented on presenter electronic device 124.

Presenter headset 122 and/or external camera(s) 150 may capture presenter 120's gestures, motions, gaze, etc. and those gestures, motions, gazes, etc. may be presented to audience 110 on audience headset 115 as an avatar of presenter 120. In addition, computer program 135 may identify actions in the gestures, motions, gazes, etc. that may affect a presentation to audience 110, such as highlighting certain data, elements, etc.

In one embodiment, computer program 135 may use a machine learning engine to detect an audience sentiment and/or to identify recommendations and/or content to present to audience 110.

Presenter 120 may independently process the feedback (e.g., audio and visual) and may adjust the presentation accordingly.

In one embodiment, presenter 120 may also consider the geographical location of the user (e.g., is the user at home, at a bank, at a marketplace, etc.) in order to better understand the user's situation. The location information may further be used by computer program 135 to determine the information to provide to audience 110, suggestions to make to presenter 120, etc.

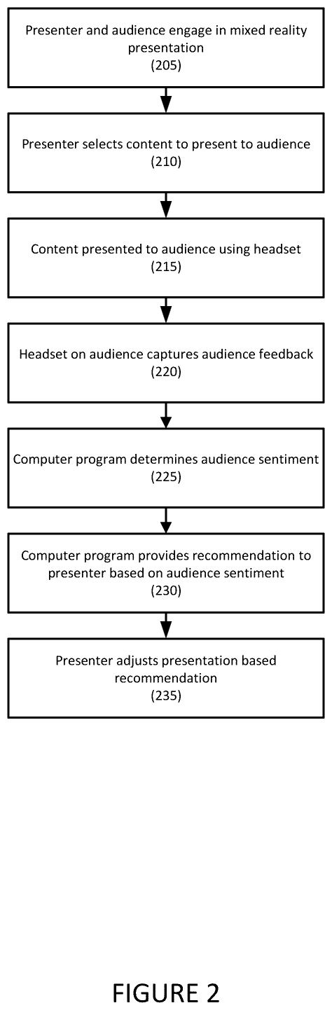

Referring to FIG. 2, a method for audience feedback guided mixed reality is disclosed according to an embodiment.

In step 205, a presenter and an audience may engage in a mixed reality presentation. In one embodiment, the presenter and the audience may be located in the same area; in another embodiment, the presenter and the audience may be in different locations.

In one embodiment, the audience may wear a headset, which may display the mixed reality environment to the audience. For example, the headset may project digital content on a glass that allows the real-world environment to be seen.

In another embodiment, the headset may include cameras that display the real-world environment on a screen.

The headset may include cameras to detect eye gaze for focal points, to detect an orientation of the headset, and/or to capture what the audience is viewing. It may also include or interface with audience monitoring device, such as heart rate monitors, EKG monitors, pulse monitors, temperature monitors, etc.

The headset may capture gestures, such as hand/arm gestures, finger pointing, walking, etc., by the audience. The gestures may be captured by camera(s) in the headset, by external camera(s) in the environment, etc.

In one embodiment, physical objects in the area, such as tables, chairs, walls, ornamental features, etc., may be displayed in the mixed reality environment. Digital content, such as charts, graphics, data, pictures, generated objects, etc. may be generated and displayed in the mixed reality environment.

The presenter may also be provided with a headset. The headset may provide similar functionality as the headset used by the audience.

The presenter may be presented to the audience as an avatar, or, if present in the same area, may be viewed by the audience in its physical form.

In step 210, the presenter may select content to present to the audience. For example, the presenter may use a presenter electronic device, such as a tablet, to select digital content to present to the audience. The presenter may also select a location for the digital content to be displayed, such as on a table, a wall, or other flat surface.

In one embodiment, the audience headset may capture features of the environment, and may identify area(s) for the digital content to be displayed. For example, using an object library, a computer program may receive the image(s) of the environment captured by the presenter's headset and may identify objects in the image(s) (e.g., table, walls, etc.). It may then identify areas for the presenter to present the digital content.

In one embodiment, the presenter may make gesture(s) that may be captured by one or more cameras in the environment, on the presenter's headset, on the audience's headset, etc. that may be interpreted to select digital content to present to the audience.

In step 215, a computer program may cause the content to be presented to audience on the headset.

In step 220, during the presentation, the headset may capture audience activity, such as eye gaze/focal point, gestures, movements, audio, etc. and may provide the feedback to the computer program.

The presenter may also separately capture feedback from the audience.

In step 225, the computer program may determine an audience sentiment, such as engaged, confused, uninterested, apprehensive, etc. from the captured audience activity. In one embodiment, the audience sentiment may be determined using a trained machine learning model.

For example, the computer program may determine that the audience is engaged because the eye focal point is on the graphic being presented, and the audience is asking questions. As another example, the computer program may determine that the audience is uninterested because the eye focal point is not on the content, the audience keeps looking at his or her watch, the audience is not asking questions, etc.

In step 230, the computer program may provide a recommendation to the presenter based on the audience sentiment. For example, the computer program may recommend that the presenter adjust the tempo of the presentation (e.g., slow down, speed up), focus on a specific area of the presentation, to be more engaging with the audience, to skip a part of the presentation, etc. It may also recommend additional content to be presented.

In one embodiment, the computer program may use a large language model to identify a recommendation. For example, the computer program may provide a large language model with a prompt of what is being presented to the audience, the audience's actions (e.g., gaze, gestures, questions, etc.), and the large language model may return a recommendation for the presenter, such as an action to take (expand a part of the digital content, adjust tempo), additional information to present, gestures to make, etc.

In one embodiment, the computer program may identify and automatically highlight content that is being discussed or addressed by the presenter. In another embodiment, the presenter may identify the content using, for example, a virtual laser pointer or similar.

The computer program may also provide the presenter electronic device with the audience view.

In step 235, the presenter may adjust the presentation based on the recommendation by, for example, adjusting the tempo, presenting additional content, etc.

The presenter may independently process the feedback (e.g., audio and visual) and may adjust the presentation accordingly.

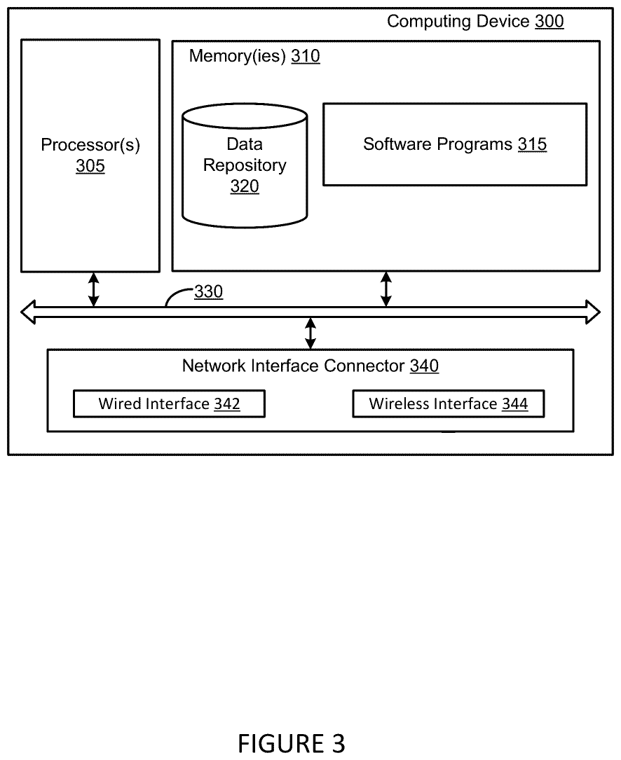

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Additional details may be found in the Appendix, the contents of which are incorporated, by reference.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed on an electronic device, an instruction from a presenter electronic device for a presenter to present a presentation comprising content to an audience headset;
communicating, by the computer program, the content to the audience headset, where the audience headset presents the content;
receiving, by the computer program, feedback from the audience headset;
determining, by the computer program, an audience sentiment based on the feedback;
identifying, by the computer program, a recommendation for the presenter based on the audience sentiment; and
communicating, by the computer program, the recommendation to the presenter electronic device.

2. The method of claim 1, wherein the content comprises augmented reality or virtual reality content.

3. The method of claim 1, wherein the content comprises three-dimensional content.

4. The method of claim 1, wherein the feedback comprises an eye gaze/focal point, a gesture, a movement, and/or audio.

5. The method of claim 1, wherein the audience sentiment is determined using a trained machine learning model.

6. The method of claim 1, wherein the recommendation comprises adjusting a tempo of the presentation.

7. The method of claim 1, wherein the recommendation comprises additional content to present.

8. The method of claim 7, wherein the additional content is identified using a large language model.

9. The method of claim 1, further comprising:
identifying, by the computer program, a portion of the content being presented; and
causing, by the computer program, the audience headset to display the portion of the content as highlighted or emphasized.

10. The method of claim 1, further comprising:
communicating, by the computer program, an audience view to the presenter electronic device, wherein the presenter electronic device displays the audience view.

11. A system, comprising:
an audience headset;
a presenter electronic device for a presenter; and
a computer program executed by an electronic device that receives an instruction from the presenter electronic device to present a presentation comprising content to the audience headset, communicates the content to the audience headset, receives feedback from the audience headset, determines an audience sentiment based on the feedback, identifies a recommendation for the presenter based on the audience sentiment, and communicates the recommendation to the presenter electronic device.

12. The system of claim 11, wherein the content comprises augmented reality or virtual reality content.

13. The system of claim 11, wherein the content comprises three-dimensional content.

14. The system of claim 11, wherein the feedback comprises an eye gaze/focal point, a gesture, a movement, and/or audio.

15. The system of claim 11, wherein the audience sentiment is determined using a trained machine learning model.

16. The system of claim 11, wherein the recommendation comprises adjusting a tempo of the presentation or additional content to present.

17. The system of claim 16, wherein the additional content is identified using a large language model.

18. The system of claim 11, wherein the computer program identifies a portion of the content being presented and causes the audience headset to display the portion of the content as highlighted or emphasized.

19. The system of claim 11, wherein the computer program communicates an audience view to the presenter electronic device and the presenter electronic device displays the audience view.

20. The system of claim 19, wherein the presenter electronic device comprises a presenter headset.
